(19) United States
(12) Patent Application Publication
(10) Pub. No.: US 2016/0232342 A1
(43) Pub. Date: Aug. 11, 2016

(54) METHOD AND SYSTEM FOR AUTHENTICATING ACCESS

(71) Applicant: Arnab GANGULY, Bangalore (IN)

(72) Inventor: Arnab GANGULY, Bangalore (IN)

(73) Assignee: Wipro Limited, Bangalore (IN)

(21) Appl. No.: 14/664,064

(22) Filed: Mar. 20, 2015

(30) Foreign Application Priority Data
Feb. 5, 2015 (IN) 572/CHE/2015

(51) Int. Cl. G06F 21/36

(52) U.S. Cl. CPC G06F 21/36

(57) ABSTRACT

Embodiments of the present disclosure disclose a method for authenticating access. The method comprises receiving a touch input from a user, where the touch input comprises selection of one or more nodes of a plurality of nodes displayed on a user interface of the system and sequence of selection of the one or more nodes. Then, method comprises determining an intensity of touch pressure on each of the selected one or more nodes. Next, the received touch input with a predefined touch input and the intensity of the touch pressure on each of the selected one or more nodes with corresponding predefined intensities of touch pressure is compared. Then, the method authenticates access to the system based on the comparison of the touch input and the comparison of the intensity of the touch pressure.

### CROSS-REFERENCE TO RELATED APPLICATION

This U.S. patent application claims priority under 35 U.S.C. §119 to: Indian Patent Application No. 572/CHE/2015, filed Feb. 5, 2015. The aforementioned application is incorporated herein by reference in its entirety.

### TECHNICAL FIELD

The present subject matter is related, in general to authentication of a user and more particularly, but not exclusively to a method and system for authenticating an access.

### BACKGROUND

Generally, system, e.g. a touch screen device provides multiple authentication techniques for locking and/or unlocking the touch screen device. Existing authentication techniques include numeric based authentication, alphanumeric based authentication, pattern based authentication, fingerprint and/or image authentication. However, the existing authentication techniques provide limited cryptographic encryption which includes shorter passwords. In such a case, the shorter passwords are easy to be cracked out. Particularly, there exists a problem in securing the passwords because the shorter passwords cane cracked using simple crypto-analysis algorithms.

The fingerprint authentication is considered to be one of the most efficient authentication techniques. The fingerprint authentication secures the access to the touch screen device. However, there exists a problem since the fingerprint authentication is used in conjunction with the numeric and/or alphanumeric and/or pattern based authentication. Also, the fingerprint authentication cannot be used if the fingers are injured. In such a case, the access to the touch screen device is non-authenticable.

Further, the existing authentication techniques cannot be used with more password complexity without the conduct of reengineering or reconfiguring the system.

In one conventional approach, method for authenticating the access is a pattern lock i.e. pattern based authentication. The pattern locking is very popular because of its interesting and fun way to unlock a mobile unlike a password entry mechanism. However, this pattern lock is vulnerable because of following reasons. Firstly, if anyone sees the pattern while unlocking by the user, they can easily remember and can hack the pattern. This is because the dots are connected via line and the connected dots are adjacent to each other. Secondly, if the screen of the mobile phone is closely observed immediately after it is unlocked, finger swipe marks can be seen on the screen which in turn leads to hacking the pattern. Gesture unlock patterns set up by an authorized user can be discovered by viewing the finger smudge path on the glass. This smudge path is particularly visible when the screen is dark and the unlock gesture is traced out many times in a more intentional fashion where the user exerts more finger pressure.

### SUMMARY

Disclosed herein are method and system for authenticating access to the system. The method comprises receiving a touch input from a user, where the touch input comprises selection of one or more nodes of a plurality of nodes displayed on a user interface of the system and sequence of selection of the one or more nodes. The method further comprises determining an intensity of touch pressure on each of the selected one or more nodes. The method further comprises comparing the received touch input with a predefined touch input and the intensity of the touch pressure on each of the selected one or more nodes with corresponding predefined intensities of touch pressure. The method further comprises authenticating access to the system based on the comparison of the touch input and the comparison of the intensity of the touch pressure.

In an aspect of the present disclosure, a system for authenticating access to the system is disclosed. The system comprises a processor and a memory communicatively coupled to the processor. The memory stores processor-executable instructions, which, on execution, cause the processor to receive a touch input from a user comprising selection of one or more nodes of a plurality of nodes displayed on a user interface of the system and sequence of selection of the one or more nodes. The processor is configured to determine an intensity of touch pressure on each of the selected one or more nodes. The processor is configured to compare the received touch input with a predefined touch input and the intensity of the touch pressure on each of the selected one or more nodes with corresponding predefined intensities of touch pressure. The processor is configured to authenticate access to the system based on the comparison of the touch input and the comparison of the intensity of the touch pressure.

In another aspect of the present disclosure, a non-transitory computer readable medium for authenticating access to a system is disclosed. The non-transitory computer readable medium includes instructions stored thereon that when processed by a processor causes the system to perform operations comprising receiving a touch input from a user comprising selection of one or more nodes of a plurality of nodes displayed on a user interface of the system and sequence of selection of the one or more nodes. An intensity of touch pressure on each of the selected one or more nodes is determined. The received touch input is compared with a predefined touch input. Also, the intensity of the touch pressure on each of the selected one or more nodes are compared with corresponding predefined intensities of touch pressure. Based on the comparison of the touch input and the comparison of the intensity of the touch pressure, access to the system is authenticated.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a illustrates a block diagram of an exemplary system with processor and memory in accordance with some embodiments of the present disclosure;

FIG. 1b illustrates a block diagram of an exemplary system with various modules for authenticating access in accordance with some embodiments of the present disclosure;

FIG. 2 illustrates exemplary system showing a plurality of nodes on a user interface of the system in accordance with some embodiments of the present disclosure;

FIG. 3 shows an exemplary diagram illustrating a visual feedback shown in concentric circles corresponding to intensities of touch pressure in accordance with some embodiments of the present disclosure;

FIG. 4 shows an exemplary diagram illustrating inputting touch pressure along with touch input in accordance with some embodiments of the present disclosure;

FIG. 5 shows a flowchart illustrating a method for authenticating access to a system in accordance with some embodiments of the present disclosure; and

FIG. 6 illustrates a block diagram of an exemplary computer system for implementing embodiments consistent with the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure are related to a method and a system for authenticating access. The system includes any such electronic devices having touch screen panel and touch pad. The method provides authentication techniques to access the system using different intensities of touch pressure on one or more password inputs. The authentication technique can be used to lock and/or unlock user interface of the system. The authentication technique comprises receiving selection of the one or more password inputs along with sequence i.e. pattern of the selection of the one or more password inputs. In an embodiment, the selection of each of the one or more password inputs is performed by applying an intensity of touch pressure. Then, the received intensity of touch pressure on each of the one or more password inputs are compared with corresponding intensity of touch pressure preconfigured for the respective password input. If the selection along with sequence of each of the one or more password inputs and the intensity matches with the preconfigured password inputs and intensities of touch pressure, then the access to the system is authenticated.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

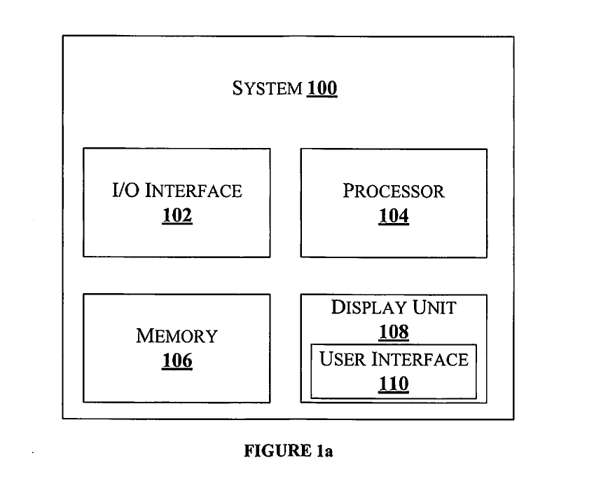

FIG. 1a illustrates a block diagram of an exemplary system 100 with a processor 102 and a memory 120 in accordance with some embodiments of the present disclosure.

Examples of the system 100 includes, but is not limited to, mobiles phones, Personal Computers (PC), laptop, desktop computer, tablet, smartwatch, cameras, notebook, pager, cellular devices, Personal Digital Assistant (PDA), Global Positioning System (GPS) receivers, Television (TV) remote controls, audio- and video-file players (e.g., MP3 players and iPODs), digital cameras, and e-book readers (e.g., Kindles and Nooks), smartphone, wearable device and the like. The system 100 refers to a touch screen device having a touch screen panel (not shown). In an embodiment, the system 100 refers to such device having a touch pad (not shown).

The system 100 may include input/output (I/O) interface 102, at least one central processing unit (“CPU” or “processor”) 104, a memory 106 and a display unit 108 comprising user interface 110.

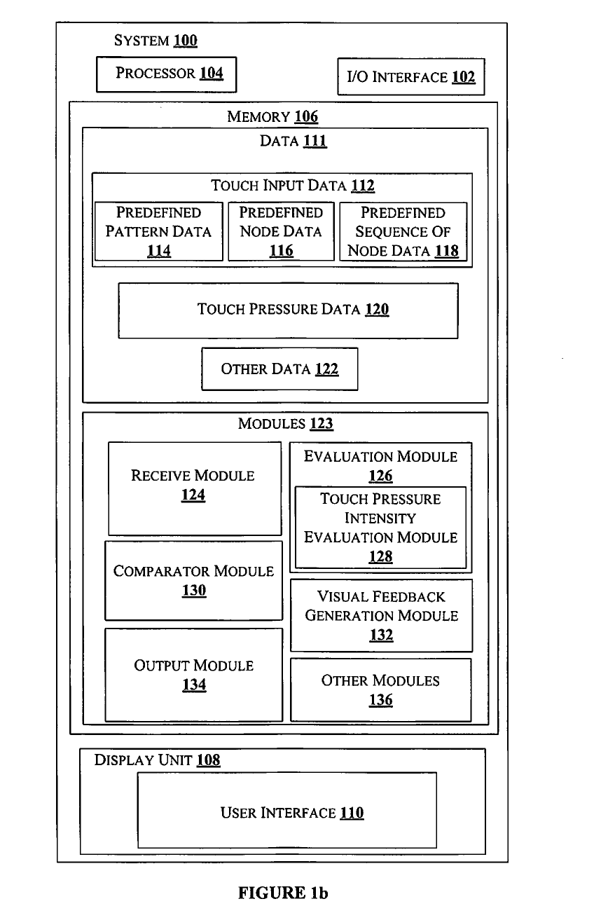

The I/O interface 102 is configured to receive a touch input which includes selection of one or more nodes of a plurality of nodes displayed on a user interface 110 of the display unit 108 of the system 100. Also, the touch input includes sequence of selection of the one or more nodes. In an embodiment, each of the plurality of nodes refers to password input and/or data to lock and/or unlock the user interface 110 of the system 100. In one example, each of the plurality of nodes may include, without limitation, numeric, alphanumeric, image and fingerprint etc. A person skilled in art should understand that the nodes may refer to such input data which can be used for authenticating the accessing to the user interface 110 of the system 100. For example, FIG. 2 illustrates exemplary system 100 showing the plurality of nodes as numeric referred to 202 on the user interface 110. In an embodiment, the I/O interface 102 is configured to receive touch pressure along with intensity of touch pressure applied by a user while selecting the one or more nodes. In an embodiment, the user may include a person, a person using a device/system such as those included in this disclosure, or such a device itself. The I/O interface 102 is configured to provide visual feedback indicating the intensity of touch pressure applied by the user on the selected one or more nodes on the user interface 110. The I/O interface 102 provides the user interface 110 for accessing to the user based on a result of authentication of the touch input and the intensity of touch pressure. In an embodiment, the I/O interface 102 is coupled with the processor 104.

The processor 104 may comprise at least one data processor for executing program components for executing user- or device-generated touch inputs. The processor 104 is configured to evaluate an intensity of touch pressure applied by the user while inputting the touch input which is received from the user through the I/O interface 102. The processor is configured to compare the touch input along with the touch pattern with a predefined touch input and touch pattern to verify on the authentication of the access to the system 100. The processor 104 is configured to provide results of authentication for display to the user interface of the system for notifying the user. In an embodiment, the processor 104 implements and executes one or more modules described in following description of the disclosure. The one or more modules perform the authentication.

The memory 106 stores instructions executable by the at least one processor 104. The memory 106 stores a predefined touch pattern, touch input and intensities of touch pressures. In an embodiment, the predefined touch pattern, touch input and intensities of touch pressures are stored as one or more data required for authentication which is described in the following description of the disclosure.

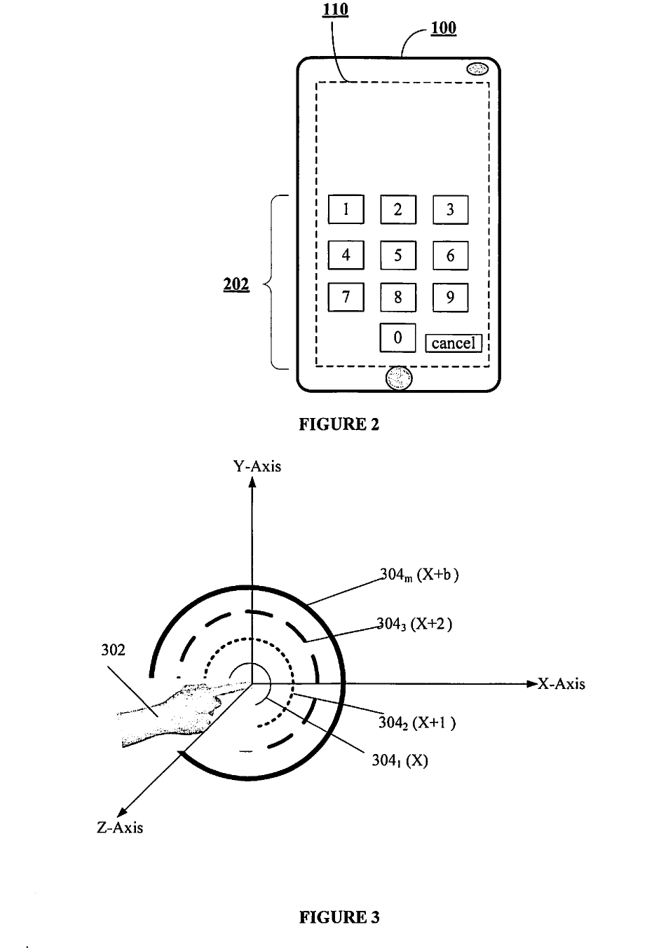

The display unit 108 is configured to provide the user interface 110 having the plurality of nodes for display. In an embodiment, the user interface 110 is a touch sensitive Graphical User Interface (GUI). In an embodiment, the user interface 110 enables the user to perform the touch pattern on the one or more nodes of the plurality of nodes for inputting the touch input. The touch pattern includes, but is not limited to, swipe, slide, poke, tap, press, pinch, gestures, movements, motions etc. The touch pattern includes such patterns which are enabled by the user interface 110 having GUI. In an embodiment, the user can input the touch pattern using a marker which includes, but is not limited to, stylus, pen, pencil, hand, finger, keyboard, mouse, joystick, (infrared) remote control, touchpad, trackball and pointing device, etc. Further, the user interface 110 enables the user to apply touch pressure while selecting the one or more nodes. In an embodiment, the user interface 110 comprises different intensities of touch pressures stored in Z-axis which is perpendicular to the plane of the user interface 110. In an example, the user is enabled to apply touch pressure in Z-axis of the user interface 110. Upon applying a particular intensity of touch pressure in Z-axis of the user interface 110, a corresponding intensity of touch pressure stored therein is determined and detected. An example of the different intensities is illustrated in FIG. 3 which is described in following description of the disclosure.

In one implementation, the user interface 110 includes one or more sensors (not shown). For example, the one or more sensors may be a touch capacitive sensor. The one or more sensor is configured to sense the touch pattern along with the touch input inputted by the user. In one implementation, the one or more sensor is configured to sense the touch pressure applied by the user while inputting the touch input.

FIG. 1b illustrates a block diagram of the exemplary system 100 with various modules for authenticating access to the system 100 in accordance with some embodiments of the present disclosure. In the illustrated FIG. 1b, the one or more data 111 and the one or more modules 123 stored in the memory 120 are described herein in detail.

In an embodiment, the one or more data 111 may include, for example, touch input data 112, touch pressure data 120 and other data 122 preconfigured for usage in authenticating the touch input received from the user in real-time.

In an embodiment, the touch input data 112 refers the touch input along with the touch pattern configured to be performed on the one or more nodes of the plurality of nodes. The touch input data 112 comprises predefined pattern data 114, predefined node data 116 and predefined sequence of node data 118.

The predefined pattern data 114 refers to the touch pattern configurable to be performed on the one or more nodes. For example, consider the user configured the poke touch pattern required to be performed on the one or more nodes for inputting the touch input. Particularly, the poke touch pattern is preconfigured to input the selection of the one or more nodes along with performing the sequence of selection of the one or more nodes. Hence, the poke touch pattern is stored as the predefined pattern data 114.

The predefined node data 116 refers to a set of the one or more nodes preconfigured by the user for authenticating the access to the system 100. For example, consider the user has configured a three digit password having 1, 2 and 5 as the one or more nodes. In such a way, the one or more numbers 1, 2 and 5 is stored as the predefined node data 116.

The predefined sequence of node data 118 refers to a sequence preconfigured by the user in which the one or more nodes to be selected. For example, consider the user has configured to select the numeric 1 followed by 2 and then followed by 5 for accessing the system 100. The sequence of 1 to 2 to 5 defines the sequence in which the one or more numeric required to be selected in real-time by the user.

The touch pressure data 120 refers to the intensities of touch pressure predefined by the user. In an embodiment, different intensities of touch pressure are used as encryption technique to authenticate the access. In such a way, unauthorized access is denied which does not match with the intensities of touch pressures predefined by the user. In one implementation, the user interface 110 is preconfigured with the different intensities of touch pressures out of which one or more intensities can be predefined by the user for authentication.

The different intensities of touch pressures and the indication of each of the different intensities are illustrated herein. For example, considering the user interface 110 is configured with four intensities of touch pressures. In an embodiment, any number of intensities of touch pressure can be configured for the user interface 110. Considering, the one or more numeric as the one or more nodes required to be inputted as a password. Each of the numeric denoted by ‘n’ can have four combinations of intensities of touch pressures i.e. n.1, n.2, n.3 and n.4. For example, the numeric ‘2’ can have four intensities of touch pressures i.e. 2.1, 2.2, 2.3 and 2.4. There exists 0 to 9 numbers and there are 40 numbers on total. In such a way, a four digit password can have 40⁴ combinations of intensities of touch pressures on total, where each numeric can have n⁴ combinations of intensities of touch pressure.

In mathematical terms, maximum number of password combinations allowed in the system 100 with total number of allowable characters Y and with length of the password ‘P’ is ‘Y^{P}’.

In an embodiment, a visual feedback of each of the intensities of touch pressures is indicated on the user interface 110 in a form of geometric shapes, for example, one or more concentric circles as shown in FIG. 3. Each of one or more concentric circles indicates corresponding intensity of touch pressure applied by the user. For example, the circle 304₁ indicates the touch pressure with intensity of ‘X’. Particularly, the circle 304₁ is displayed on the user interface 110 when the intensity of touch pressure applied by the user is ‘X’. The circle 304₂ indicates the touch pressure when the intensity of touch pressure is ‘X+1’ and so on. In an embodiment, ‘M’ number of concentric circles can be preconfigured for one node which is denoted by 304ₘ and there can be ‘b’ number of intensities of touch pressures denoted by ‘X+b’. In an embodiment, if ‘M’ number of concentric circles is generated against each numeric ‘n’, then there are ‘M*n’ possible selectable combinations for numeric ‘n’. Hence, for a total number of allowable characters Y, length of password length of P and M number of concentric circles against each numeric n there are (M*Y)^{P} number of possible password combinations.

The other data 122 may refer to such data which can be preconfigured in the system 100 for enabling the authentication process.

In an embodiment, the one or more data 111 in the memory 109 are processed by the one or more modules 123 of the system 100. The one or more modules 123 may be stored within the memory 106 as shown in FIG. 1b. In an example, the one or more modules 123, communicatively coupled to the processor 104, may also be present outside the memory 106. Particularly, the one or more data 111 in the memory 106 including the touch pattern, the touch input and the touch pressure are used by the one or more modules 123. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In one implementation, the one or more modules 123 may include, for example, receive module 124, evaluation module 126, comparator module 130, visual feedback generation module 132 and output module 134. The processor 104 may also comprise other modules 136 to perform various miscellaneous functionalities of the system 100. It will be appreciated that such aforementioned modules may be represented as a single module or a combination of different modules.

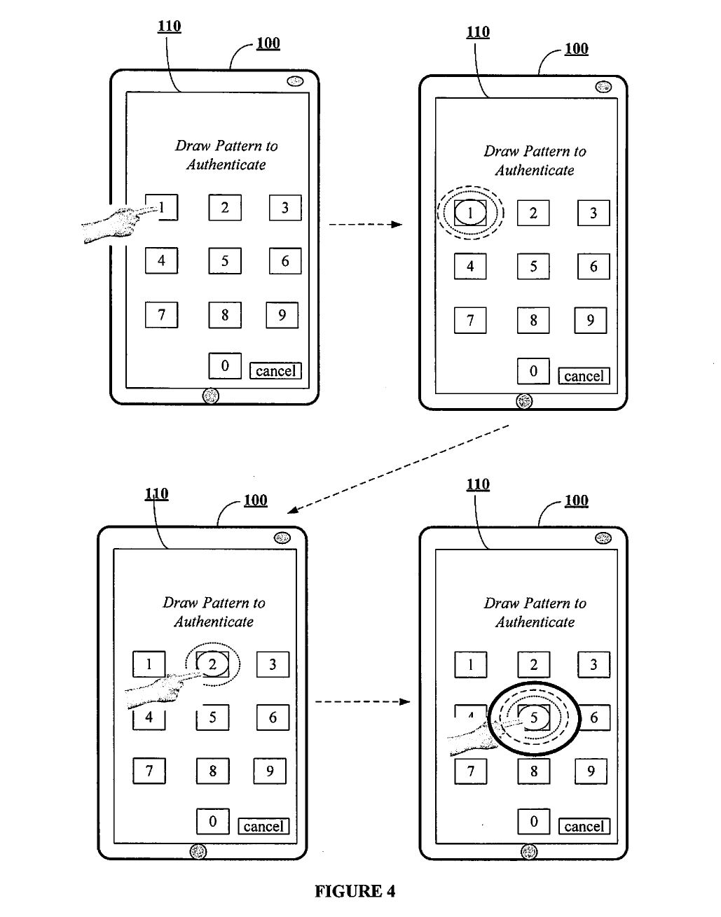

In an embodiment, the receive module 124 receives a touch pattern and a touch input from the one or more sensors which senses the touch pattern and the touch input from the user. For example, considering the user inputs poke touch pattern on the user interface 110 and using the poke touch pattern, the user inputs the touch input. Considering the user inputs the touch input as ‘1’ with touch pressure of intensity ‘X+2’ followed by ‘2’ with touch pressure of intensity ‘X+1’ followed by ‘5’ with intensity of ‘X+3’ as shown in FIG. 4. In an embodiment, the visual feedback generation module 132 generates the visual feedback on the user interface 110 as shown in FIGS. 3 and 4. In an embodiment, the visual feedback generation module 132 generates the concentric circles against each selection of the one or more nodes respectively to indicate the intensity of touch pressure while the user is selecting the one or more nodes. The poke touch pattern and the touch input are sensed by the one or more sensors which is in turn received by the receive module 124.

The evaluation module 126 is configured to evaluate the touch pattern and the touch input along with intensities of touch pressure applied by the user. The evaluation module 126 comprises a touch pressure intensity evaluation module 128. The touch pressure intensity evaluation module 128 is configured to evaluate or determine the intensities of touch pressure applied on each of the one or more nodes. For example, the touch pressure intensity evaluation module 128 evaluates the intensity to be ‘X+2’ with which the numeric ‘1’ is selected by the user and intensity of ‘X+2’ with which numeric ‘2’ is selected and so on.

The comparator module 130 compares the received touch input along with the touch pattern with a predefined touch input stored as the touch input data 112. Also, the comparator module 130 compares the received intensity of touch pressure on each of the selected one or more nodes with corresponding predefined intensities of touch pressures stored as the touch pressure data 120. Based on the comparison of the touch input along with the touch pattern and comparison of the intensity of the touch pressure, the comparator module 130 authenticates the access to the system 100. Particularly, the comparator module 130 authenticates the access when the received touch input matches with the predefined touch input and when the intensity of the touch pressure on each of the selected one or more nodes matches with the corresponding predefined intensities of touch pressure. For example, considering the poke touch pattern is preconfigured. Also, the one or more nodes predefined by the user as password to be 1, 2 and 5. Considering, the sequence and intensities of touch pressure predefined by the user for the node ‘1’ with ‘X+2’ followed by node 2 with ‘X+1’ followed by node 5 with ‘X+3’. Now, in real-time, assuming the user inputs node ‘1’ with ‘X+2’ followed by node 2 with ‘X+1’ followed by node 5 with ‘X+3’. The received touch input and the intensities of touch pressure matches with the predefined touch input and corresponding predefined intensities of touch pressures. Hence, upon determining the matching, the comparator module 130 authenticates the access to the system 100.

The output module 134 is configured to output the result of the authentication to the user interface 110 for user display. In an embodiment, the output module 134 provides an alert when the intensity of touch pressure received from the user is equal to a maximum predefined intensity of touch pressure of the predefined intensities of touch pressure. For example, considering the touch pressure of intensity ‘X+4’ configured to be the maximum predefined intensity of touch pressure. Therefore, if the user applies the intensity of ‘X+4’ or greater than the intensity ‘X+4’, the output module 134 provides the alert to the user interface 110 for user notification. In an embodiment, the alert can be provided in one or more forms which includes, but is not limited to, visual alert by displaying concentric circle, audio alert, vibration of the system 100 and microelectromechanical based alerts.

The other modules 136 processes all such operations required to authenticate the access to the system 100.

It may be understood to a person skilled in the art that the intensity of touch pressure may be used along various authentication techniques, such as the finger print authentication, the numeral authentication, alphanumeric authentication and image authentication etc. In exemplary embodiment, in finger print authentication, the touch pressure applied by the user while inputting the finger print is taken as the touch input. Then, the matching of the touch pressure and the fingerprint with a predefined touch pressure and the fingerprint is determined. Upon determining the match, the access to the system 100 is authenticated. Likewise, in image authentication, the user has to apply touch pressure on the user interface 110 while inputting the image. Upon determining the match of the touch pressure and the image with the predefined touch pressure and the image, access to the system 100 is authenticated.

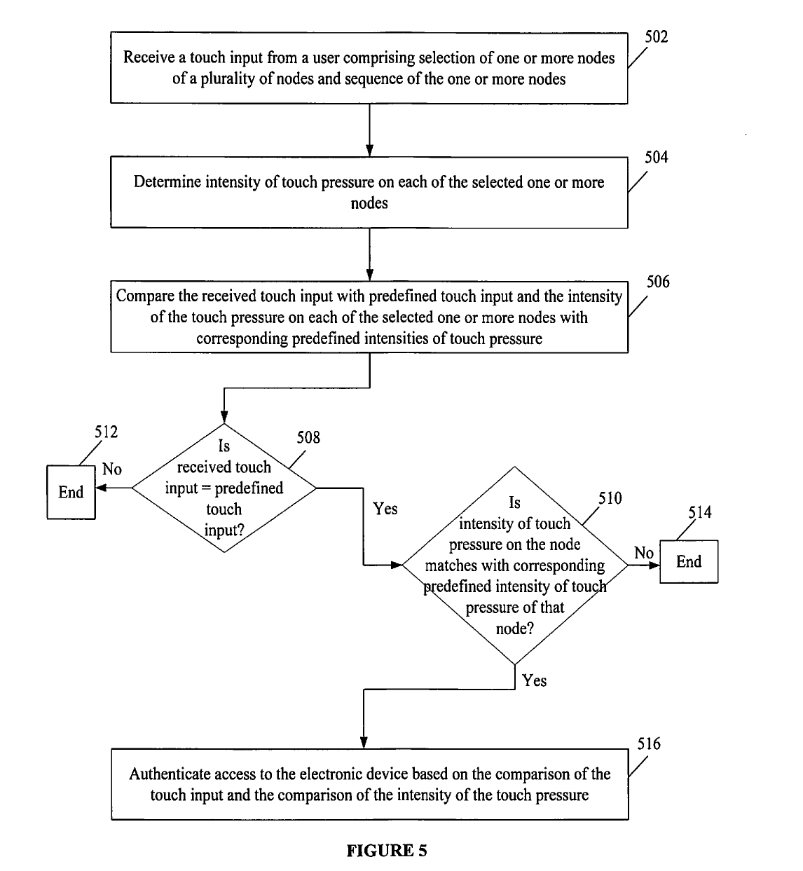

FIG. 5 shows a flowchart illustrating a method for authenticating access to the system 100 in accordance with some embodiments of the present disclosure.

As illustrated in FIG. 5, the method comprises one or more blocks for storing a pattern for authenticating the access to the system 100. The method may be described in the general context of computer executable instructions. Generally, computer executable instructions can include routines, programs, objects, components, data structures, procedures, modules, and functions, which perform particular functions or implement particular abstract data types.

The order in which the method is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 502, the system 100 senses the touch pattern and the touch input received from the user on the user interface 110. In an embodiment, the system 100 senses the touch pattern and the touch input using the one or more sensors (not shown). In an embodiment, the visual feedback is generated. Particularly, the visual feedback including the generation of the concentric circles on the user interface 110 is generated to indicate the intensity of touch pressure for each of the selected one or more nodes respectively.

At block 504, the system 100 determines the intensity of touch pressure on each of the selected one or more nodes. Particularly, the intensity of touch pressure received for each of the selected one or more nodes is evaluated.

At block 506, the system 100 compares the received touch input with the predefined touch input and the intensity of the touch pressure on each of the selected one or more nodes with corresponding predefined intensities of touch pressure.

At block 508, the system 100 checks whether the received touch pattern and the touch inputs matches with the predefined touch pattern and the predefined touch input stored in the memory 106. If the received touch pattern and the touch inputs does not match with the predefined touch pattern and the predefined touch input, then the process stops at block 512 via “No”. If the received touch pattern and the touch inputs matches with the predefined touch pattern and the predefined touch input, then the process goes to block 510 via “Yes”.

At block 510, the system 100 checks whether received intensity of touch pressure on each of the one or more nodes matches with the corresponding predefined intensity of touch pressure of the respective one or more nodes. If received intensity of touch pressure on each of the one or more nodes does not match with the corresponding predefined intensity of touch pressure of the respective one or more nodes, then the process ends at block 514 via “No”. If received intensity of touch pressure on each of the one or more nodes matches with the corresponding predefined intensity of touch pressure of the respective one or more nodes, then the process goes to block 516 via “Yes”.

At block 516, the access to the system 100 is authenticated.

### Computer System

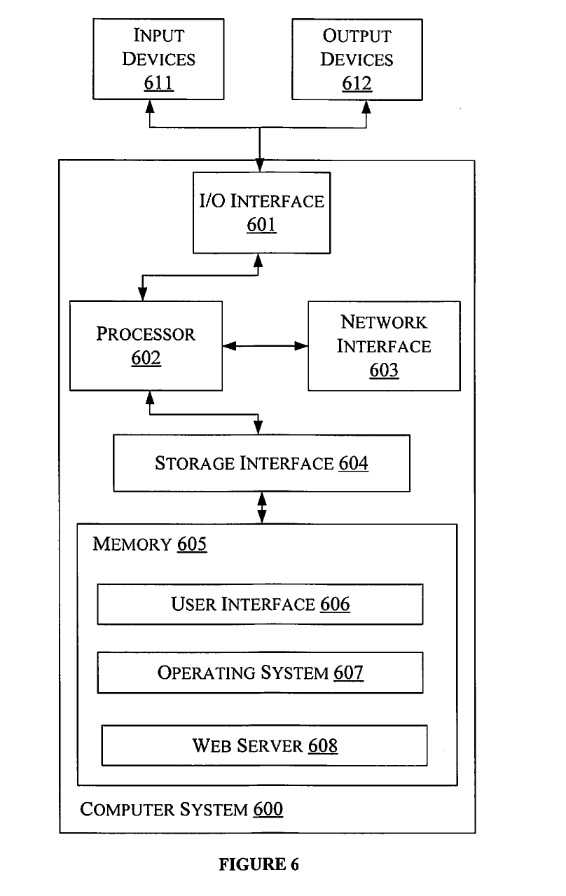

FIG. 6 illustrates a block diagram of an exemplary computer system 600 for implementing embodiments consistent with the present disclosure. In an embodiment, the computer system 600 is used to implement the system 100. The computer system 600 authenticates the access to the system 100. The computer system 600 may comprise a central processing unit (“CPU” or “processor”) 602. The processor 602 may comprise at least one data processor for executing program components for executing user- or system-generated touch inputs. A user may include a person, a person using a device such as those included in this disclosure, or such a device itself. The processor 602 may include specialized processing units such as integrated system (bus) controllers, memory management control units, floating point units, graphics processing units, digital signal processing units, etc.

The processor 602 may be disposed in communication with one or more input/output (I/O) devices (611 and 612) via I/O interface 601. The I/O interface 601 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the computer system 600 may communicate with one or more I/O devices (611 and 612). For example, the input device 611 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 612 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processor 602 may be disposed in communication with a memory 605 (e.g., RAM, ROM, etc. not shown in FIG. 6) via a storage interface 604. The storage interface 604 may connect to memory 605 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, user interface application 606, an operating system 607, web server 608 etc. In some embodiments, computer system 600 may store user/application data, such as the data, variables, records, etc. as described in this disclosure. Such databases may be implemented as fault-tolerant, relational, scalable, secure databases such as Oracle or Sybase.

The operating system 607 may facilitate resource management and operation of the computer system 600. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 606 may facilitate display, execution, interaction, manipulation, or operation of program components through textual or graphical facilities. For example, user interfaces may provide computer interaction interface elements on a display system operatively connected to the computer system 600, such as cursors, icons, check boxes, menus, scrollers, windows, widgets, etc. Graphical 3 (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 600 may implement a web browser 608 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 600 may implement a mail server stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 600 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, nonvolatile memory, hard drives, CD ROMs, DVDs, flash drives, disks, and any other known physical storage media.

Advantages of the embodiment of the present disclosure are illustrated herein.

Embodiments of the present disclosure provide an authentication technique to use the touch pressure as encryption. In this way, unauthorized access to the system is denied and is not processed.

Embodiments of the present disclosure enable the user to input the touch pressure in Z-axis perpendicular to the plane of the user interface. In such a way, the user is not required to remember longer passwords.

Embodiments of the present disclosure provide advanced technique of locking and/or unlocking the user interface using the touch pressure.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 5 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | System |
| 102 | I/O Interface |
| 104 | Processor |
| 106 | Memory |
| 108 | Display Unit |
| 110 | User Interface |
| 112 | Touch Input Data |
| 114 | Predefined Pattern Data |
| 116 | Predefined Node Data |
| 118 | Predefined Sequence of Node Data |
| 120 | Touch Pressure Data |
| 122 | Other Data |
| 124 | Receive Module |
| 126 | Evaluation Module |
| 128 | Touch Pressure Intensity Evaluation |
| | Module |
| 130 | Comparator Module |
| 132 | Visual Feedback Generation Module |
| 134 | Output Module |
| 136 | Other Modules |
| 202 | Nodes |
| 302 | User |
| 304₁, | Concentric Circles |
| 304₂, . . . , 304ₘ | |

What is claimed is:

1. A method for authenticating access to a system, the method comprising:
receiving, by the system, a touch input from a user comprising selection of one or more nodes of a plurality of nodes displayed on a user interface of the system and sequence of selection of the one or more nodes;
determining, by the system, an intensity of touch pressure on each of the selected one or more nodes;
comparing, by the system, the received touch input with a predefined touch input and the intensity of the touch pressure on each of the selected one or more nodes with corresponding predefined intensities of touch pressure; and
authenticating, by the system, access to the electronic device based on the comparison of the touch input and the comparison of the intensity of the touch pressure.

2. The method as claimed in claim 1 further comprising generating by the system, a visual feedback on the user interface of the system to indicate the intensity of touch pressure.

3. The method as claimed in claim 2, wherein the visual feedback comprises generating concentric circles for the selected one or more nodes respectively on the user interface to indicate the intensity of touch pressure.

4. The method as claimed in claim 1 further comprising providing access to the system upon determining:
matching of the received touch input with the predefined touch input; and
matching of the intensity of the touch pressure on each of the selected one or more nodes with the corresponding predefined intensities of touch pressure.

5. The method as claimed in claim 1, wherein the predefined touch input is defined by the user, said predefined touch input comprises one or more nodes of a plurality of nodes and a predefined sequence of selection of the one or more nodes.

6. The method as claimed in claim 1, wherein the selection of the one or more nodes is performed by at least one of swipe, slide, poke, tap, press, and gestures on the one or more nodes.

7. The method as claimed in claim 1 further comprising providing by the system, an alert when the intensity of touch pressure received from the user is equal to a maximum predefined intensity of touch pressure of the predefined intensities of touch pressure.

8. A system for authenticating access comprising:
a processor;
a memory communicatively coupled to the processor, wherein the memory stores processor-executable instructions, which, on execution, cause the processor to:
receive a touch input from a user comprising selection of one or more nodes of a plurality of nodes displayed on a user interface of the system and sequence of selection of the one or more nodes;
determine an intensity of touch pressure on each of the selected one or more nodes;
compare the received touch input with a predefined touch input and the intensity of the touch pressure on each of the selected one or more nodes with corresponding predefined intensities of touch pressure; and
authenticate access to the system based on the comparison of the touch input and the comparison of the intensity of the touch pressure.

9. The system as claimed in claim 8, wherein the processor is further configured to generate a visual feedback on the user interface of the system to indicate the intensity of touch pressure.

10. The system as claimed in claim 9, wherein the visual feedback comprises generating concentric circles for the selected one or more nodes respectively on the user interface to indicate the intensity of touch pressure.

11. The system as claimed in claim 8, wherein the processor is configured to provide access to the system upon determining:
the received touch input to be matching with the predefined touch input; and
the intensity of the touch pressure on each of the selected one or more nodes to be matching with the corresponding predefined intensities of touch pressure.

12. The system as claimed in claim 11, wherein the predefined touch input is defined by the user, said predefined touch input comprises one or more nodes of a plurality of nodes and a predefined sequence of selection of the one or more nodes.

13. The system as claimed in claim 8, wherein the selection of the one or more nodes is performed by at least one of swipe, slide, poke, tap, press, and gestures on the one or more nodes.

14. The system as claimed in claim 8, wherein the processor is further configured to provide an alert when the intensity of touch pressure received from the user is equal to a maximum predefined intensity of touch pressure of the predefined intensities of touch pressure.

15. A non-transitory computer readable medium including instructions stored thereon that when processed by a processor cause a system to perform acts of:
receiving a touch input from a user comprising selection of one or more nodes of a plurality of nodes displayed on a user interface of the system and sequence of selection of the one or more nodes;
determining an intensity of touch pressure on each of the selected one or more nodes;
comparing the received touch input with a predefined touch input and the intensity of the touch pressure on each of the selected one or more nodes with corresponding predefined intensities of touch pressure; and
authenticating access to the system based on the comparison of the touch input and the comparison of the intensity of the touch pressure.

16. The medium as claimed in claim 15, wherein the instructions further cause the processor to perform operations comprising generating a visual feedback on the user interface of the system to indicate the intensity of touch pressure.

17. The medium as claimed in claim 16, wherein the visual feedback comprises generating concentric circles for the selected one or more nodes respectively on the user interface to indicate the intensity of touch pressure.

18. The medium as claimed in claim 15, wherein the instructions further cause the processor to perform operations comprising providing access to the system upon determining:
matching of the received touch input with the predefined touch input; and
matching of the intensity of the touch pressure on each of the selected one or more nodes with the corresponding predefined intensities of touch pressure.

19. The medium as claimed in claim 15, wherein the predefined touch input is defined by the user, said predefined touch input comprises one or more nodes of a plurality of nodes and a predefined sequence of selection of the one or more nodes

20. The medium as claimed in claim 15, wherein the instructions further cause the processor to perform operations comprising providing an alert when the intensity of touch pressure received from the user is equal to a maximum predefined intensity of touch pressure of the predefined intensities of touch pressure.
